(19) United States
(12) Patent Application Publication
(10) Pub. No.: US 2005/0198934 A1
(43) Pub. Date: Sep. 15, 2005

(54) Round baler reclamation belt

(75) Inventor: Aaron J. Johnson, Jamestown, ND (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Duratech Industries International, Inc., Jamestown, ND (US)

(21) Appl. No.: 10/799,261

(22) Filed: Mar. 12, 2004

(51) Int. Cl. A01D 39/00

(52) U.S. Cl. 56/341

(57) ABSTRACT

A material reclaiming conveyor is positioned below the apron of a round baler. The apron has a series of side by side bale forming belts that are spaced apart and form a bale chamber. The conveyer underlies an in-feed region to the bale chamber to catch material falling through the spaces between the bale forming belts and convey the material forwardly, to be recycled into the in-feed region of the baler. A trough is provided under an in-feed drum to receive the material from the reclaiming conveyer and cause such material to be carried with the drum into the bale forming chamber.

### BACKGROUND OF THE INVENTION

The present invention relates generally to “round balers” which form cylindrical bales of crop material, and more particularly, to a reclamation conveyor that is mounted below the bale forming chamber to recover leaves and short stems that have been torn from the crop being baled, and drops through gaps or openings, and that returns such high nutrient components to be recycled into the baled material.

Round balers are widely used at the present time, and, generally utilize a series of belts that accept a swath or windrow of hay crop from a pick up and in feed roller or drum feed system. The hay is fed into the baler chamber, and as a bale starts to form in the inlet throat of the baler, that is, between a starter roller and a support drum, the belts or rollers will tend to tear off leaves and short stems in high quality hay crops such as alfalfa. The leaves and stems that are torn off will fall between the openings in the series of side by side belts used commonly for forming the round bale, or other gaps and thus will be lost.

It is well known that the leaves, in particular, are high in the digestive nutrients in a hay crop such as alfalfa, and so loss of such high quality components is detrimental.

The reclamation conveyor is designed primarily for use with a round baler that utilizes a series of bale forming belts that are positioned side by side and that have spaces between the side by side belts, particularly in the region where hay is being fed into the bale chamber.

Prior art round balers are shown in U.S. Pat. Nos. 4,899,651; 4,870,812; 5,444,969; and 6,098,391. A round baler which uses rolls for forming the bales is shown in U.S. Pat. No. 4,765,237.

### SUMMARY OF THE INVENTION

The present invention relates to a reclamation conveyor that catches materials that are dropped or dislodged from crop material as the crop material enters the baling chamber of a round baler and return the material to the baler in feed for recycling into a bale being formed. The reclaiming of the crop material is accomplished by utilizing a conveyer, as shown, a belt or belts below the in-feed of a round baler.

The conveyor is preferably driven whenever the baler is operated, and receives crop materials that drop through gaps in the bale forming belts or rollers on its upper surface and move the dropped crop material back toward the in-feed region of the baler. Particularly the reclaimed material is fed into a trough below a rotating feeder drum which transfers material from the trough into the baler in-feed region. The leaves and short stems returned to the in-feed region will be picked up and carried with incoming crop material, such as hay, and mixed in and retained in the incoming windrow of material, and thus retained in the bale being formed.

The reclaiming conveyor of the present invention is mounted on the baler frame. As shown, the reclaiming conveyor belt support rollers extend transversely to the baler and transversely to the direction of movement of the bale forming belts. The conveyor rollers are parallel to the axis of the bale being formed. The reclaiming conveyor is preferably formed as a self-contained assembly of a frame, belt rollers and a belt mounted over the belt rollers. The conveyor can have a selected fore and aft length but generally is of sufficient length to underlie the entire in-feed area of a baler where the feed drums and rollers engage the incoming hay and tend to shatter or tear the leaves and small tender stems from the main plant stems.

The surface of the reclaiming belts can be smooth or have irregularities, as desired. The drive to the rollers can either be chain or belt drives from driven rollers on the baler, or can be a hydraulic motor utilized for driving one of the conveyor belt rollers.

A single endless belt that extends the full width of the baler is preferred to reduce or prevent any materials that are deposited on the top surface of the belt from falling through onto the ground.

The reclaiming conveyor provides a saving of high quality portions of the hay or other crop materials, which increases the food value of the baled material, thus benefiting a cattle feeding operation.

### BRIEF DESCRIPTION OF THE DRAWINGS

FIG. 1 is a side schematic view of a typical round baler with the bale forming chamber illustrated only schematically,

FIG. 2 is a rear view of the baler of FIG. 1;

FIG. 3 is a schematic representation of a reclaiming belt assembly made according to the present invention installed in lower portions of a baler, below the in-feed region where crop material enters the bale chamber;

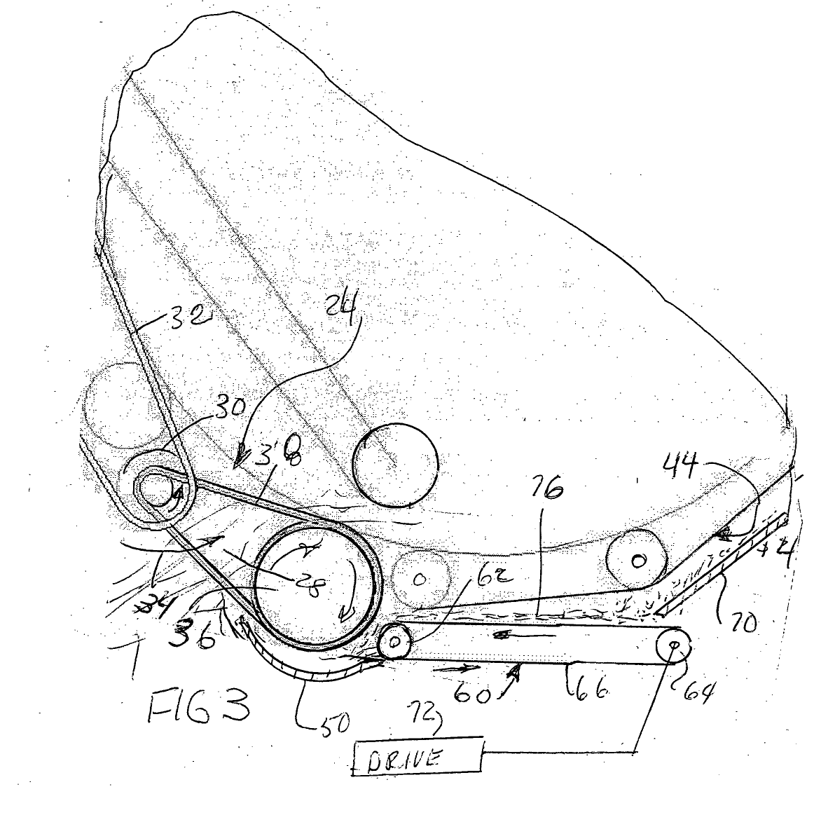

FIG. 4 is an enlarged rear view of one side of the reclaiming belt of the present invention showing the position of the frame of the baler;

FIG. 5 is an enlarged fragmentary side view of a reclaiming conveyor installed on a baler; and

FIG. 6 is a perspective view of a reclaiming conveyor assembly.

### DETAILED DESCRIPTION OF THE PREFERRED EMBODIMENTS

A baler 10 which is a “round” baler has a main frame 12 that is made up of a number of interconnected structural elements. The baler frame 12 has side walls 14, and has an expandable bale chamber defined partially by a dotted representation of a round bale inside an apron 44 that forms the bale, expandable bale chamber 16 is in the center portions of the baler. The frame 12 and side walls 14 are supported on wheels 18, and a tongue 19 is used for connecting the baler to a tractor.

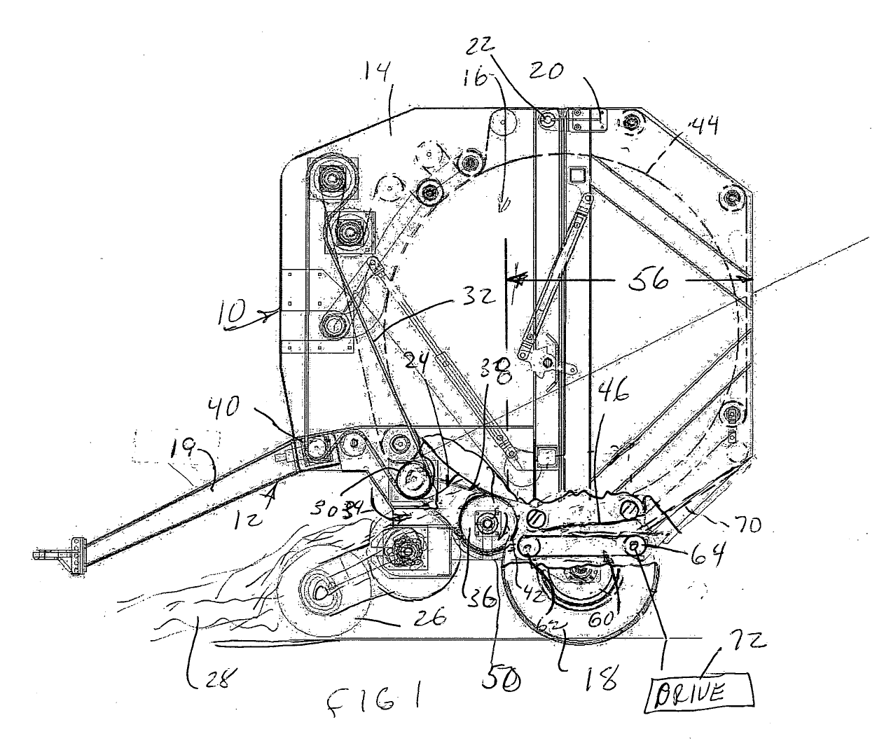

The baler includes a tailgate section 20 that is closed during bale formation, as shown in FIG. 1, but is hinged to the front portion of the baler at the top of the wall 14, and can be opened so the bottom of the tailgate swings out to drop a bale onto the ground after the bale is formed. The tailgate 20 is pivoted to the side frame for the walls 14 on pivot shafts 22 at the top, and is open and closed with hydraulic cylinders in a conventional manner.

The bale forming chamber has a hay inlet indicated generally at 24, which receives incoming hay from a pick up 26 that engages a window or swath of hay (crop material) on the ground and which transports the swath upwardly over the pick up. The hay swath is represented at 28 schematically, and is moved across suitable guides into the inlet 24.

A bale starter roller that is illustrated at 30 is rotatably mounted on the side walls 14 and is driven in a suitable manner, as shown schematically with a chain drive 32, and rotates in direction as indicated by the arrow 34 to urge hay from the hay swath or source 28 into the bale chamber through the inlet or throat 24. A support drum 36 is also suitably driven with a chain 38 that is represented only in dotted lines.

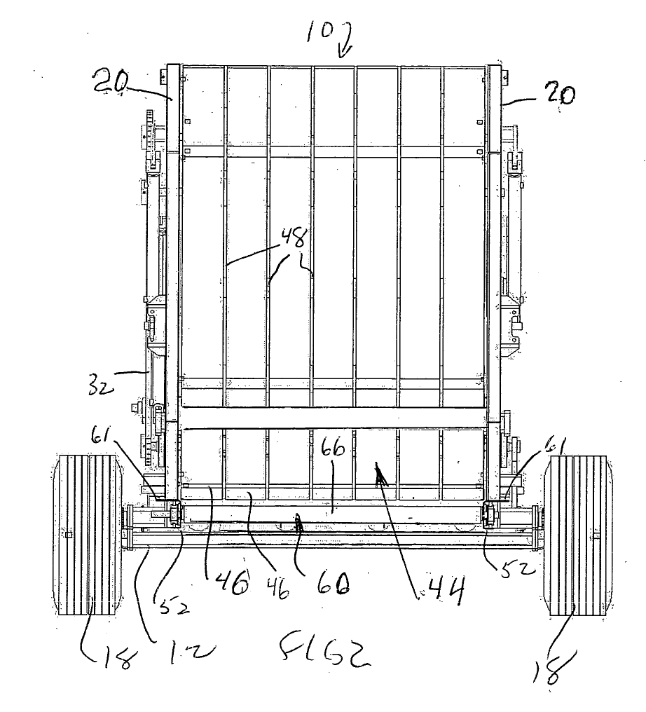

It should be noted that a power take off connection 40 can be used for driving the baler components, or suitable hydraulic motors can be utilized for drivers as well. The support drum 36 is rotated in a direction as indicated by the arrow 42, to urge the hay into the bale forming chamber. The bale forming chamber is conventional, and is further defined by the apron 44, which in FIG. 1 surrounds the bale that is formed. As can be seen in FIG. 2, the bale forming apron 44 is made up of a plurality of side by side belts 46, mounted on suitable transversely extending drive rollers and guide rollers, in a conventional manner.

The bale forming belts 46, as can be seen are spaced apart with slot like openings 48 between the bale forming belts. The openings are large enough to permit passage of leaves or short stems through the slots. In the throat area 24, the starter roller 30 and the support drum 36 can strip, jar or vibrate leaves and short stems off the hay plant main stalks, and these leaves and short stems will drop through the openings 48 between the bale forming belts 46 of the apron that forms the bale.

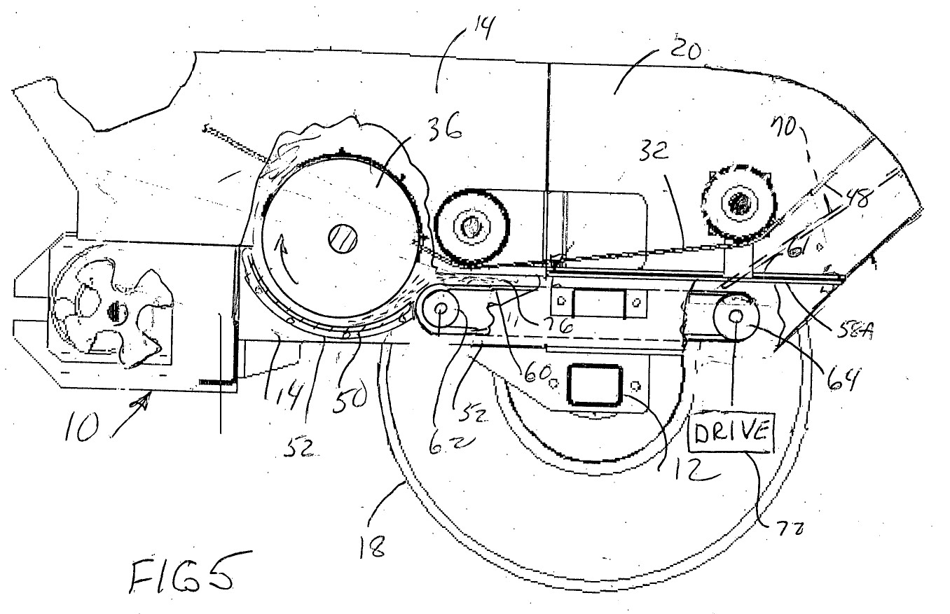

In order to provide for a recovery of such leaves, short stems and other materials that drop through the slots 48, the present invention includes a trough 50 that is part cylindrical, and spaced below the lower portions of the support drum 36. The trough 50 is fastened using suitable side flange members 52 as perhaps best seen in FIG. 5. The trough 50 extends laterally along the entire length of the support drum 36 between side walls 14. The trough 50 is imperforate, and it will catch and hold material that is deposited in the trough, which is then returned to the bale chamber by drum 36.

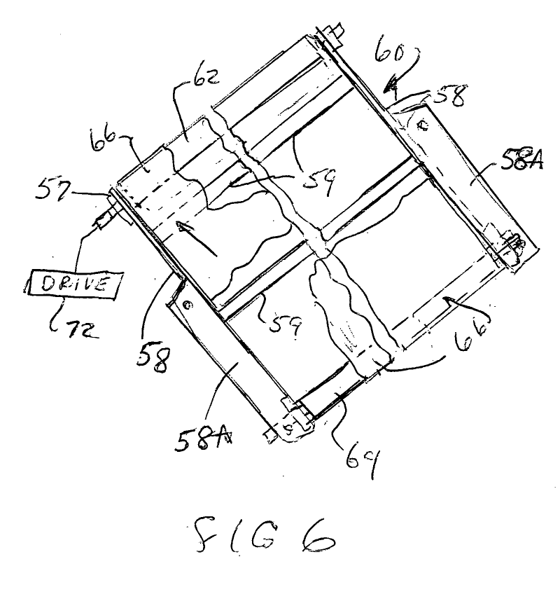

It can be seen that the main region for shattering, stripping, and dropping leaves is to the rear side of the drum 36, spanning the lower side of the entire bale forming region all the way to the rear wall of the tailgate, represented generally by the double arrow 56 (FIG. 1). In this region, the majority of the loose leaves and the like would be dropped, and to reclaim these leaves a reclaiming conveyer assembly indicated generally at 60 is supported on the side walls 14 of the baler. The conveyor assembly is preferably a self-contained conveyor or belt assembly having a frame 57 that include longitudinal side frame member 58 held together with cross members shown at 59 (FIG. 6).

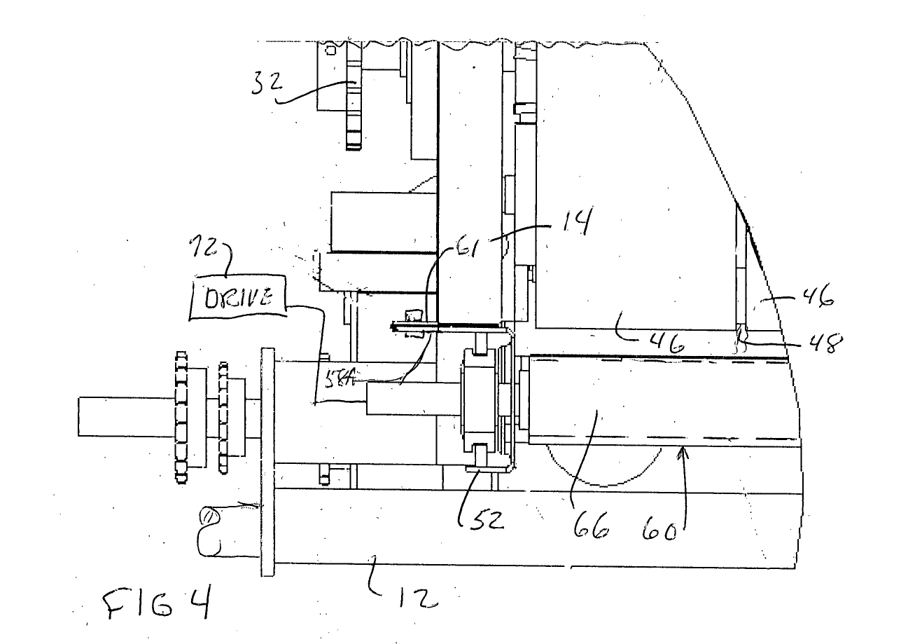

End belt support rollers 62 and 64, respectively, are rotatably supported on the side frame members 58, as can be seen in FIGS. 2, 4, and 6. The conveyer belt support rollers 62 and 64 carry a solid surface (imperforate) full width belt 66. This is preferably a continuous belt surface across the width of the baler.

The tailgate has an inclined bottom wall 70 that catch materials dropping through rear portions of the tailgate. The wall 70 is inclined sufficiently so the material slides down onto the top of the reclaiming belt 66 and the material is then returned to the trough 50.

The reclaiming conveyor assembly 60 is suitably powered by driving front roller 62. The conveyor assembly is held in place by fasteners from flanges or supports 61 on the tail gate 20 that support flanges 58A on the conveyor frame members 58. The conveyor assembly 60 thus moves with the tail gate when it pivots rearwardly as a formed bale is dropped. The conveyor drive is represented only schematically at 72, because it can be any desired type of drive which will move with the tail gate.

The conveyer belt 66 moves so that the top length of the conveyer belt 66 is moving forwardly toward the trough 50, and it will deposit loose crop materials on the top of the belt, such as leaves and stems indicated at 76, into the trough 50. The loose crop material will be carried around the support drum 36 and into the flow of hay (the windrow or swath 28) coming into the inlet or throat region 24. The reclaimed leaves and stems will be mixed in with the hay swath or windrow, and will then be processed and held in place in the formed bale.

The fore and aft length of the conveyer assembly 60 can be selected to be as desired, and the drive speed can also be selected to accomplish the purposes of returning the dropped materials 76 that have fallen through the openings 48 between the bale forming belts 46 (or other openings in balers using rolls for bale forming) onto sloping wall 70 and onto the conveyer assembly 60 and into the trough 50 for re-processing.

Again, the types of drives for the conveyer assembly 60 can be as desired. The position of the conveyer assembly 60 on a round baler having a plurality of side by side belts that are spaced to form gaps, is below the general crop material inlet area of the baler where the greatest losses of the highly nutritious leaves of crop plant such as alfalfa occur. Sloping or tapering walls such as wall 70 can be used to aid in returning materials to the conveyor.

Although the present invention has been described with reference to preferred embodiments, workers skilled in the art will recognize that changes may be made in form and detail without departing from the spirit and scope of the invention.

1. In a baler forming a crop material into a cylindrical bale and including a mainframe, a bale forming chamber comprising a bale chamber having a plurality of bale forming members, and an in-feed region for urging crop material into the bale chamber to be formed into a bale by the bale forming members, the improvement comprising a conveyer positioned below the in-feed region and underlying the bale forming members, said conveyer having a conveyor member for receiving crop material passing through gaps in the bale forming members, and a support and drive for moving the conveyer member toward an in-feed members on the baler to deposit crop material on the conveyor member onto the in-feed member.

2. The baler improvement of claim 1 wherein said conveyor extends across a lateral width of the baler, and is of length in a fore and aft direction to underlie the in-feed region of the baler.

3. The baler improvement of claim 1 wherein the in feed region includes an upper starter roller for engaging an upper surface of an in-feeding stream of crop material, a support drum that supports a lower side of the in-feeding stream for crop material, and an imperforate trough underlying the support drum, the conveyer being positioned so the conveyor member deposits material on the conveyer member into the trough, to be carried by the support drum to the in-feed region of the baler.

4. The baler improvement of claim 1 wherein the bale forming members comprises a plurality of side by side belts having spaces between adjacent belts.

5. The baler improvement of claim 4 wherein the conveyer comprises a belt conveyor including a forward roller extending between fore and aft frame members, and a rear roller on the frame members positioned parallel to the forward roller, and the conveyer member comprising an endless belt mounted over the forward and rear rollers.

6. The baler improvement of claim 5 and a power drive to drive one of the forward and rear rollers.

7. The baler improvement of claim 5 wherein the baler has a tail gate hinged at a top and pivotal to open a bottom to remove a bale, the conveyor being mounted on the tail gate.

8. The baler improvement of claim 5 and a trough for recovery of material carried on the belt conveyor, a drum cooperating with the trough to move material from the trough to the in-feed region of the baler.

9. A reclaiming belt conveyor for mounting onto a baler forming round bales and having a bale forming apron made up of a plurality of bale forming belts that have gaps between the bale forming belts in a transverse direction, said belt conveyer comprising a conveyor belt having a surface positioned below the bale forming belts, said belt conveyer being driven to move an upper surface of the conveyor belt toward an in-feed region of the baler.

10. The reclaiming belt conveyer of claim 9, wherein the baler has a pick up for picking up a stream of crop material, and rollers for guiding the stream of crop material into a bale forming chamber, one of the rollers comprising a drum on the lower side of the stream of crop material, a trough below the drum for supporting material on an underside of the drum in position to being engaged by the drum and carried with the drum to the bale forming chamber, and the belt conveyer being positioned such that one end of the belt conveyer deposits material into the trough.

11. The reclaiming belt conveyor of claim 9 wherein the belt conveyor is mounted on a frame having fore and aft extending side frame members, a pair of rollers rotatably mounted on the frame, and cross members between the side frame members.

12. The reclaiming belt conveyor of claim 11 wherein the conveyor belt comprises a continuous belt extending a full width of the bale forming chamber on the rollers.

13. The reclaiming belt conveyor of claim 9 wherein the bale forming chamber has an in-feed region for feeding material into the in-feed region, material feed rollers in the in-feed region for moving material into the in-feed region, the belt conveyor being below the in-feed region.

14. The reclaiming belt conveyor of claim 13 wherein the material feed rollers include a support roller below a path for the feeding material, a trough below the support roller, and the belt conveyor being positioned to deposit material in the trough.
